(19) United States
(12) Patent Application Publication
(10) Pub. No.: US 2005/0288007 A1
(43) Pub. Date: Dec. 29, 2005

(54) Network integration with invisible fencing systems

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 10/877,608

(22) Filed: Jun. 25, 2004

(51) Int. Cl. H04Q 7/20

(52) U.S. Cl. 455/422.1

(57) ABSTRACT

Embodiments of the system and method may be for monitoring a movable object. One embodiment of the method may have the steps of: attaching a monitor unit to a movable object; forming an invisible boundary that is detectable by the monitor unit; linking the invisible boundary and monitoring unit to at least one mobile terminal; selectively turning on and off power to the invisible boundary from the mobile terminal; detecting when the monitor unit crosses the invisible boundary and sending a signal to the mobile terminal indicative therefore; and detecting a low battery condition of the monitor unit and sending a signal to the mobile terminal indicative therefore.

### TECHNICAL FIELD

The present invention relates generally to telecommunication, and in particular to providing a feature that allows a mobile subscriber to be aware of a pet's location and to be able to remotely control and monitor an invisible fencing system.

### BACKGROUND OF THE INVENTION

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate electronic phonebooks, speed dialing, single button voicemail access, and messaging capabilities, such as e-mail.

However, there are still drawbacks in the prior art in other peripheral areas where a user wants to monitor a situation but there is no convenient and practical way to do it. One such area concerns the confinement of pets with what is known as an invisible fence.

One known prior art invisible fence has a transmitter that sends a radio signal that is picked up by the pet's computer equipped collar. The transmitter plugs into a standard outlet and emits a radio signal that travels along an underground wire. The lightweight receiver worn on the pet's collar picks up the radio signal and alerts him with a warning beep as he nears the underground boundary. If he continues toward the boundary, he will receive a mild correction, similar to a static shock.

Another known wireless fence has a transmitter that is plugged into an electrical outlet somewhere in the house. The transmitter emits a radio signal around the house. The pet wears a lightweight receiver collar, which listens for the signal. While the collar is receiving the signal, the dog is free to run and play in the yard. When he approaches the boundary of the signal area, he receives a warning beep. If the dog does not return, he receives a static correction, which is startling but not harmful.

In this wireless system the signal field can be adjusted anywhere from a 15 to 90 foot radius from the transmitter. The shape of the signal is in a perfect circle and the shape cannot be altered.

As good as these systems claim to be, it is still possible for a pet to cross the invisible fence, for example, when he is very frightened. This may occur, for example, when the owner is not home, and a sudden storm panics the pet. It is also a drawback of these systems that once the pet is outside the fence, the fence will prevent him from returning home.

Therefore, there is a need in the art for an improved invisible fence system, in particular a system that keeps the owner aware of the pet's location. In particular, it is desirable to be able to remotely control and monitor the invisible fencing systems.

### SUMMARY

The invention in one implementation encompasses a system for monitoring a movable object. One embodiment of the system may have: a monitor unit attached to a movable object; an invisible boundary that is detectable by the monitor unit; and a telecommunication link that effects communication at least from the invisible boundary and monitor unit to at least one mobile terminal.

Another implementation of the present invention encompasses a method for monitoring a movable object that may have the steps of: attaching a monitor unit to a movable object; forming an invisible boundary that is detectable by the monitor unit; linking the invisible boundary and monitoring unit to at least one mobile terminal; selectively turning on and off power to the invisible boundary from the mobile terminal; detecting when the monitor unit crosses the invisible boundary and sending a signal to the mobile terminal indicative therefore; and detecting a low battery condition of the monitor unit and sending a signal to the mobile terminal indicative therefore.

### BRIEF DESCRIPTION OF THE DRAWINGS

Features of exemplary implementations of the invention will become apparent from the description, the claims, and the accompanying drawings in which:

FIG. 1 depicts a block diagram that illustrates elements of a system according to one embodiment for providing a feature that allows a mobile subscriber to keep aware of a pet's location and remotely control and monitor an invisible fencing system.

FIG. 2 depicts a block diagram that illustrates elements of an invisible fence control unit and an invisible fence system.

FIG. 3 illustrates a very general flow chart of logical operational steps that may be followed in accordance with one embodiment of the present method and system.

FIG. 4 illustrates a more detailed flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

Embodiments of the present system and method provide for remote control and monitoring of invisible fencing systems through the use of a mobile terminal, such as a cell phone. This network functionally allows a mobile subscriber the convenience of being able to be notified via a phone call or SMS message that the pet has exceeded its boundaries. Typically, it would be necessary to subscribe to this network feature. Knowing when exactly the pet escaped would aid in the chances of recovering the pet since the recovery actions could begin immediately upon notification. Upon notification, via the mobile terminal, the mobile subscriber could also remotely turn off the invisible fencing system so that the pet could safely get back into the fenced area without being shocked a second time. Additional functionality may include turning the system on and off, or being notified via an SMS text message that the battery level in the dog's collar is low and needs to be replaced.

It is to be understood that the term invisible fence system may refer to a variety of means for enclosing areas or means for providing a line which when crossed produces some effect, such as emitting a tone, causing a shock, setting off a remote alarm, etc. The wire or other structure may not be actually invisible, but means that a pet, for example, may actually physically cross the wire or structure.

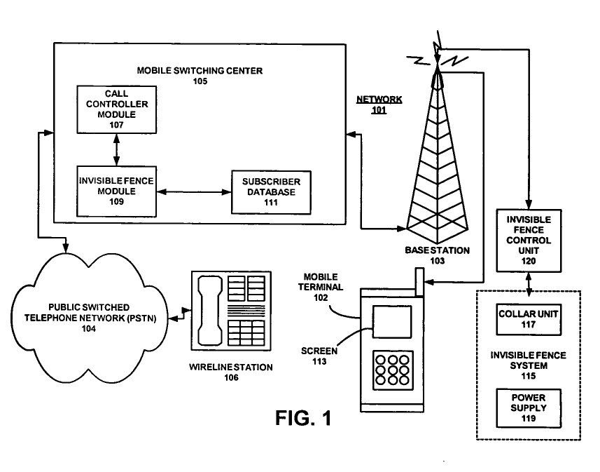

In the FIG. 1 embodiment a network 101 is operatively connected to at least one mobile terminal 102. As is known the network 101 may have at least one base station 103, which is operatively connected to a mobile switching center 105, wirelessly coupled to the mobile terminal 102. The mobile switching center 105 in the network 101 may also have a call control module 107 operatively connected to base station 103 and to an invisible fence module 109. A database 111 may also be operatively connected to an invisible fence module 109.

Via the call controller module 107, the invisible fence module 109 is operatively connected to the invisible fence control unit 120 that interfaces and controls the invisible fence system 115, which has a collar unit 117 and a power supply 119.

The network 101 may be, or may be part of, one or more of a telephone network, a local area network (“LAN”), the Internet, and a wireless network. In the depicted embodiment, a public switched telephone network (PSTN) 104 is connected to the mobile switching center 105. The PSTN 104 routes calls to and from mobile users through the mobile switching center 105. The PSTN 104 also routes calls from and to wireline stations 106. The PSTN 104 generally may be implemented as the worldwide voice telephone network accessible to all those with telephones and access privileges (e.g., AT&T long distance network).

Thus the telecommunications network 101 serves as a point of control for the invisible fencing system 115 (e.g. turn the system on or off remotely) with a subscription to this network feature. Furthermore, the invisible fencing system 115 may report alarms (pet escape, low battery, etc.) to mobile terminal 102 by means of a phone call or an SMS message that may be displayed on the screen 113. The type and form of the message may be dependent on the severity of the condition. Information and instructions may be stored in the database 111.

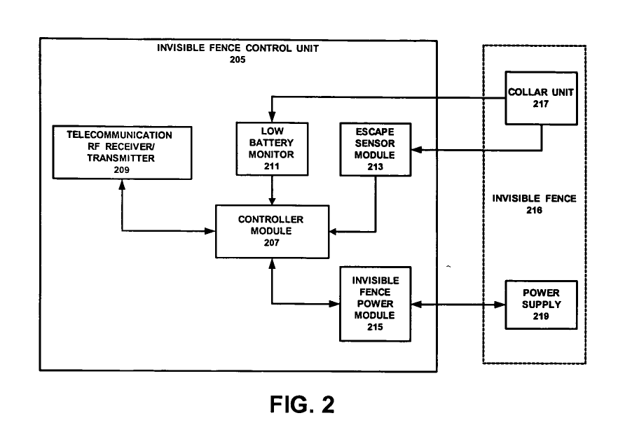

As depicted in FIG. 2, embodiments of the present system and method may be implemented by modifying the invisible fencing control unit 205 to include RF receiver/transmitter 209 that is compatible with frequencies used in telecommunications networks. The RF receiver/transmitter 209 may be operatively connected to a controller module 207 that provides general control and interfacing of the elements of the invisible fence control unit 205 to the invisible fence 215 and at least one collar unit 217. It is to be understood that the collar unit 217 is representative of a variety of different units such as, units that are attached by clips, tape, etc. to the subject, such as an animal.

The controller module 207 may control power to the power supply 219 of the invisible fence 215 via an invisible fence power module 216. Thus via the mobile terminal, the mobile subscriber can remotely activate or deactivate the invisible fencing system 215 as long as the mobile subscriber has subscribed to this network feature. The invisible fence power module 216 turns the power supply 219 on and off in response to signals received from the mobile terminal.

In the event of a break-out condition, the invisible fencing system may initiate a call to the respective mobile terminal or generate an SMS message to inform the subscriber of a pet escape. The escape sensor module 213 receives a signal from the collar unit 217 when the pet is within an area defined by the invisible fence 215. In one embodiment the escape sensor module 213 indicates an escape when the signal from the collar unit 217 falls below a predetermined threshold. Alternately, the escape sensor module 213 may detect a change in a signal from the collar unit 217 when it crossed a boundary of the area defined by the invisible fence 215.

In the event of a low battery condition on the pet's collar, an SMS Message or phone call to the mobile terminal may be made to inform the mobile subscriber of the low battery condition. A low battery monitor 211 is operatively connected between the controller module 207 and the collar unit 217. Numerous systems are known for monitoring a battery level.

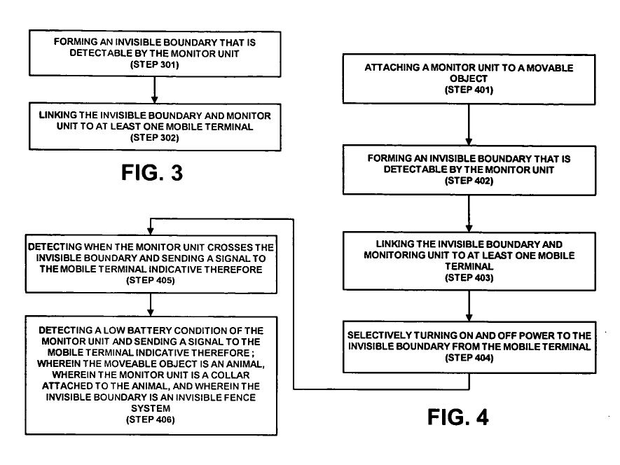

Referring to FIG. 3, one embodiment is depicted of a general method for monitoring a movable object having a monitor unit. This embodiment of the method may have the steps of forming an invisible boundary that is detectable by the monitor unit (step 301); and linking the invisible boundary and monitor unit to at least one mobile terminal (step 302).

Referring to FIG. 4, one embodiment is depicted of a more specific method for monitoring a movable object having a monitor unit. This embodiment of the method may have the steps of: attaching a monitor unit to a movable object (step 401); forming an invisible boundary that is detectable by the monitor unit (step 402); linking the invisible boundary and monitoring unit to at least one mobile terminal (step 403); selectively turning on and off power to the invisible boundary from the mobile terminal (step 404); detecting when the monitor unit crosses the invisible boundary and sending a signal to the mobile terminal indicative therefore (step 405); and detecting a low battery condition of the monitor unit and sending a signal to the mobile terminal indicative therefore (step 406); wherein the moveable object is an animal, wherein the monitor unit is a collar attached to the animal, and wherein the invisible boundary is an invisible fence system.

Embodiments of the present system and method provide a methodology for the telecommunications network to serve as a point of control for invisible fencing systems (e.g. turn the system on or off remotely) with a subscription to this network feature.

Embodiments of the present system and method further provide a methodology for an invisible fencing system to report alarms (pet escape, low battery, etc.) to a respective mobile subscriber by means of a phone call or an SMS message. The type and form of the message may be dependent on the severity of the condition.

Thus embodiments of the present system and method fulfill a need in the prior art for an improved invisible fence system, in particular a system that keeps the owner aware of the pet's location. Embodiments of the present system and method further provide for remote control and monitoring of the invisible fencing system.

The present system and method may be used with non-mobile phones and terminals, as well as, mobile phones and mobile terminals. Also, different types of data storage devices may be used with the present method and system. For example, a data storage device may be one or more of a magnetic, electrical, optical, biological, and atomic data storage medium.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that variations modifications, and the like can be made without departing from the spirit of the invention and these are therefore considered to be within the scope of the invention as defined in the following claims.

1. A method for monitoring a movable object having a monitor unit, comprising the steps of:
forming an invisible boundary that is detectable by the monitor unit; and
linking the invisible boundary and monitor unit to at least one mobile terminal.

2. The method according to claim 1, wherein the moveable object is an animal, wherein the monitor unit is a collar attached to the animal, and wherein the invisible boundary is an invisible fence system.

3. The method according to claim 1, wherein the method further comprises the step of selectively turning on and off power to the invisible boundary from the mobile terminal.

4. The method according to claim 1, wherein the method further comprises the step of detecting when the monitor unit crosses the invisible boundary and sending a signal to the mobile terminal indicative therefore.

5. The method according to claim 1, wherein the method further comprises the step of detecting a low battery condition of the monitor unit and sending a signal to the mobile terminal indicative therefore.

6. A method for monitoring a movable object, comprising the steps of:
attaching a monitor unit to a movable object;
forming an invisible boundary that is detectable by the monitor unit;
linking the invisible boundary and monitoring unit to at least one mobile terminal;
selectively turning on and off power to the invisible boundary from the mobile terminal;
detecting when the monitor unit crosses the invisible boundary and sending a signal to the mobile terminal indicative therefore; and
detecting a low battery condition of the monitor unit and sending a signal to the mobile terminal indicative therefore.

7. The method according to claim 6, wherein the moveable object is an animal, wherein the monitor unit is a collar attached to the animal, and wherein the invisible boundary is an invisible fence system.

8. A system that monitors a movable object, comprising:
a monitor unit attached to a movable object;
an invisible boundary that is detectable by the monitor unit; and
a telecommunication link that effects communication at least from the invisible boundary and monitor unit to at least one mobile terminal.

9. The system according to claim 8, wherein the moveable object is an animal, wherein the monitor unit is a collar attached to the animal, and wherein the invisible boundary is an invisible fence system.

10. The system according to claim 8, wherein the system further comprises a controller module operatively connected to the monitor unit and to the invisible boundary, and an invisible fence power module operatively connected to the controller module and to the invisible boundary for selectively turning on and off power to the invisible boundary from the mobile terminal.

11. The system according to claim 8, wherein the system further comprises a controller module operatively connected to the monitor unit and to the invisible boundary, and an escape sensor module operatively connected to the controller module and to the monitor unit for detecting when the monitor unit crosses the invisible boundary and sending a signal to the mobile terminal indicative therefore.

12. The system according to claim 8, wherein the system further comprises a controller module operatively connected to the monitor unit and to the invisible boundary, and a low battery monitor operatively connected to the controller module and to the monitor unit for detecting a low battery condition of the monitor unit and sending a signal to the mobile terminal indicative therefore.

13. A system that monitors an animal, comprising:
at least one collar unit attached respectively to at least one animal;
an invisible fence that is detectable by the collar unit;
a controller module operatively connected to the collar unit and to the invisible fence;
a telecommunication receiver/transmitter operatively connected to the controller module for providing a telecommunication link that effects communication at least from the invisible fence and collar unit to at least one mobile terminal;
an invisible fence power module operatively connected to the controller module and to the invisible fence for selectively turning on and off power to the invisible fence from the mobile terminal;
an escape sensor module operatively connected to the controller module and to the collar unit for detecting when the collar unit crosses the invisible fence and sending a signal to the mobile terminal indicative therefore; and
a low battery monitor operatively connected to the controller module and to the collar unit for detecting a low battery condition of the collar unit and sending a signal to the mobile terminal indicative therefore.

14. A method for monitoring a movable object having a monitor unit, comprising the steps of:
forming an invisible boundary that is detectable by the monitor unit;
linking the invisible boundary and monitor unit to at least one mobile terminal in a telecommunication network;
detecting when the monitor unit crosses the invisible boundary; and
sending a signal to the mobile terminal indicative of the monitor unit crossing the invisible boundary.

15. The method according to claim 14, wherein the moveable object is an animal, wherein the monitor unit is a collar attached to the animal, and wherein the invisible boundary is an invisible fence system.

16. The method according to claim 14, wherein the at least one mobile terminal in the telecommunication network is a point of control for the invisible boundary.

17. The method according to claim 14, wherein the method further comprises the step of selectively turning on and off power to the invisible boundary from the mobile terminal.

18. The method according to claim 14, wherein the method further comprises the step of detecting a low battery condition of the monitor unit and sending a signal to the mobile terminal indicative therefore.

19. The method according to claim 14, wherein a signal is sent to the mobile terminal a phone call or an SMS message that is displayed on the screen of the mobile terminal.

20. The method according to claim 14, wherein the crossing of the invisible boundary by the monitor unit is classified according to severity, and wherein a type and form of the signal is dependent on the severity.
